(19) United States
(12) Patent Application Publication
(10) Pub. No.: US 2012/0117240 A1
(43) Pub. Date: May 10, 2012

(54) SYSTEMS AND METHODS FOR ALLOCATING NETWORK BANDWIDTH

(75) Inventor: Hassan M. OMAR, Mt. Vernon, NY (US)

(73) Assignee: Verizon Patent and Licensing Inc., Basking Ridge, NJ (US)

(21) Appl. No.: 12/940,605

(22) Filed: Nov. 5, 2010

(51) Int. Cl. G06F 15/16

(52) U.S. Cl. 709/226

(57) ABSTRACT

A mobility aware content delivery network is designed to provide content quickly and efficiently to mobile users traveling within the network. In order to enhance content delivery, such a network may collect data regarding user mobility patterns and content preferences, as well as correlation data regarding the relationship between mobility events and demand for specific contents. This collected data may be used to create a utilization map that describes that users' expected mobility patterns and expected content usage information. The utilization map may be used to identify appropriate locations in which to place contents within the network in order to enhance network performance.

### BACKGROUND OF THE INVENTION

A content delivery network (CDN) is a system that provides end users with efficient access to content at various locations in a network. In order to provide efficient delivery of content, CDNs typically utilize nodes located strategically within the network (e.g., an appliance). Generally, such nodes are processor-based elements with computer-readable memory capable of storing content and providing such content as needed within the network. By storing content on appliances located closer to the end users on the network that desire to access the content, CDNs may increase the quality of service provided to end users and, therefore, enhance user experiences on the network.

Traditional content delivery networks are most often focused on stationary users and contain no special accommodations for mobile users. The dynamic nature of a mobility environment imposes challenges to CDN support not often encountered by CDNs designed to provide service to stationary users. These challenges may include the wide range of technologies serviced by mobile networks and the diversity of features available to mobile users according to service areas in which those users are located. Despite these challenges, users in a mobile environment typically expect to experience a quality of service comparable with that they receive when operating in a stationary environment (e.g., while connected to the Internet at home via a personal computer).

### BRIEF DESCRIPTION OF THE DRAWINGS

The accompanying drawings, which are incorporated in and constitute part of this specification, and together with the description, illustrate and serve to explain the principles of various exemplary embodiments.

FIG. 1 is an exemplary diagram of a content delivery network that supports a hierarchical mobile communications protocol, in accordance with an embodiment.

FIG. 2 is a flowchart depicting exemplary modules and exemplary components used to support a mobility aware content delivery network, in accordance with an embodiment.

FIG. 3 is an exemplary diagram of a mobility pattern of a mobile device traveling along within a mobility aware content delivery network, in accordance with an embodiment.

FIG. 4 is an exemplary diagram of a mobility pattern and a distribution of contents within an exemplary mobility aware content delivery network, in accordance with an embodiment.

FIG. 5 is an exemplary timeline of events associated with distributing contents within an exemplary mobility aware content delivery network, in accordance with an embodiment.

FIG. 6 is a flowchart illustrating an exemplary process flow among components and modules supporting an exemplary mobility aware content delivery network, in accordance with an embodiment.

FIG. 7 is a diagram of an exemplary neural network that may be used to support predicting a distribution of content within a network, in accordance with an embodiment.

### DESCRIPTION OF THE EMBODIMENTS

Reference will now be made in detail to the exemplary embodiments implemented according to the disclosure, the examples of which are illustrated in the accompanying drawings. Wherever possible, the same reference numbers will be used throughout the drawings to refer to the same or like parts.

Embodiments herein include computer-implemented methods, tangible non-transitory computer-readable mediums, and systems. The computer-implemented methods may be executed, for example, by a processor that receives instructions from a non-transitory computer-readable storage medium. Similarly, a system described herein may include a processor and a memory, and the memory may be a non-transitory computer-readable storage medium. As used herein, a non-transitory computer-readable storage medium refers to any type of physical memory on which information or data readable by a processor may be stored. Examples include random access memory (RAM), read-only memory (ROM), volatile memory, nonvolatile memory, hard drives, CD ROMs, DVDs, flash drives, disks, and any other known physical storage medium. Singular terms, such as “memory” and “computer-readable storage medium,” may additionally refer to multiple structures, such a plurality of memories and/or computer-readable storage mediums. As referred to herein, a “memory” may comprise any type of computer-readable storage medium unless otherwise specified. A computer-readable storage medium may store instructions for execution by a processor, including instructions for causing the processor to perform steps or stages consistent with an embodiment herein. Additionally, one or more computer-readable storage mediums may be utilized in implementing a computer-implemented method. The term “computer-readable storage medium” should be understood to include tangible items and exclude carrier waves and transient signals.

In order to address deficiencies associated with traditional content delivery networks, which are typically designed for providing content to stationary users, exemplary methods and systems are described herein to support a mobility aware content delivery network. In a general embodiment, a pattern of mobility and content preference may be extracted from predictive information to determine a location in a content delivery network. The predictive information relates to a mobile user's pattern of movement in the network and to a likelihood the user will request the content in the future. The content is then advantageously pre-positioned at the determined location prior to a request from a user for the content. In this manner, provisioning the content delivery with particular content at the determined location enhances the ability of the content delivery network to serve a mobile user.

In a more detailed embodiment, one or more nodes of the network collect predictive types of information about a mobile user's respective movement and content preference. For example, by collecting information regarding the mobility patterns of individual mobile users and groups of mobile users, content preferences of mobile users, and correlations between mobility events and users' demand for specific contents, a map may be created from the extracted information. The map describes expected mobility patterns and expected content usage information. This map may be utilized to reach an enhanced decision regarding where, when, and how to place content on the network. Such strategic placement of content reduces the impact of mobility events on performance metrics associated with content delivery to a mobile user of the network and, thus, provides both increased quality of service and enhanced user experience.

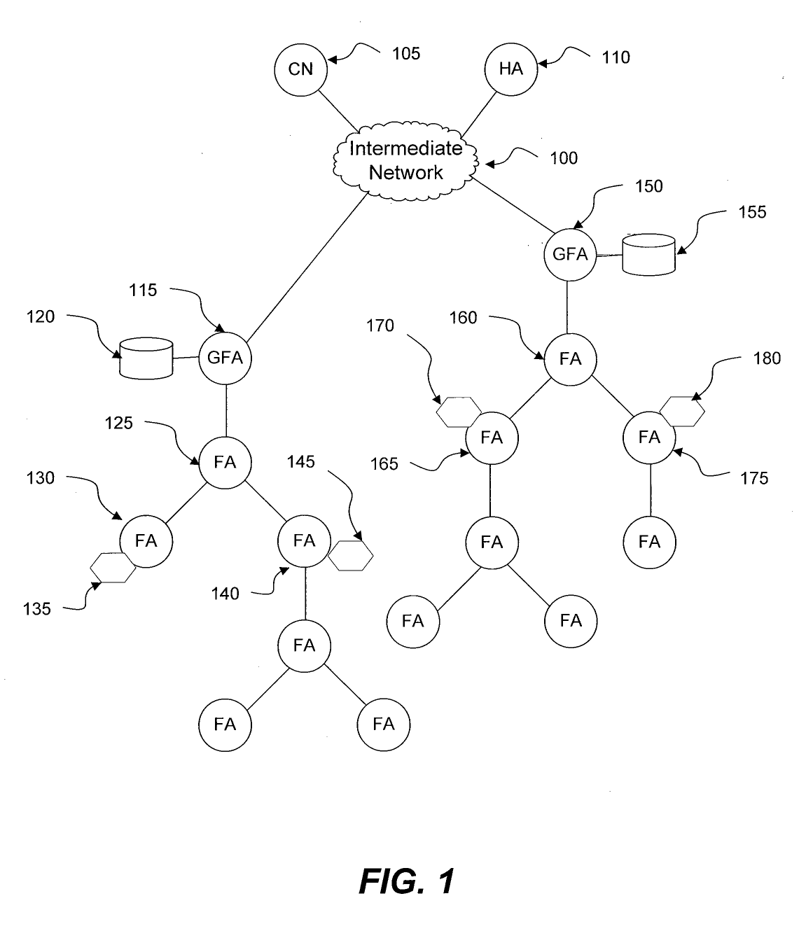

FIG. 1 depicts an exemplary content delivery network supporting mobility using a hierarchical Mobile IP model. In general, Mobile IP is a communications protocol designed to allow a mobile device to move among a number of different networks and maintain the same Internet Protocol (IP) address in each of those networks. The components of an exemplary mobility aware content delivery network supporting this protocol may include, but are not limited to, a correspondent node (CN) 105, home agent (HA) 110, foreign agents (FA), such as foreign agents 115 and 125, storage appliances, such as storage appliances 120 and 155, and cache appliances, such as cache appliances 135 and 170. By providing a number of foreign agents through which to transmit information to mobile devices and distributing storage and cache appliances at locations within the network, a mobility aware content delivery network allows for content to be strategically placed in a manner that facilitates quick and efficient delivery to the mobile users who request them.

A home agent 110 stores information regarding a mobile device having a permanent IP address within the home agent's network. The home agent 110 typically keeps track of the location at which a mobile device assigned to the home agent's network is currently receiving service. A foreign agent, such as foreign agent 115 or 125, stores information regarding the mobile devices visiting the foreign agent's network. Home agent 110 and foreign agent 125, for example, may work together to deliver a message to a mobile device whose home network is serviced by home agent 110 while the mobile device is visiting an area serviced by foreign agent 125. A gateway foreign agent (GFA), such as GFA 115 or 150, functions to connect one or more foreign agents, such as foreign agents 125 and 160, to an intermediate network 100, so that foreign agents on one side of the connecting network may communicate with a home agent, such as home agent 110, on the other side. In one example, information related to the location of a mobile device may be distributed over a number of foreign agents constituting the lineage from the gateway foreign agent at the top of the hierarchy to the leaf foreign agent serving the mobile device on a lower level of the hierarchy. For example, a mobile device may be in the area serviced by foreign agent 130. Home agent 110 may store the, information indicating that the mobile device is receiving service from gateway foreign agent 115, so that traffic from a correspondent node 105 destined to the mobile device is forwarded to the home agent 110 and then to gateway foreign agent 115. Gateway foreign agent 115 may store the information that traffic intended for delivery to the mobile device needs to be forwarded to the next foreign agent along the hierarchy, foreign agent 125.

In order to provide that contents may be quickly and efficiently delivered to mobile users, an exemplary mobility aware content delivery network in an embodiment may include one or more appliances on which to store contents, such as storage appliances 120 and 155, and cache appliances 135, 145, 170, and 180. A storage appliance, which may be connected to a foreign agent, such as gateway foreign agents 115 and 150, may store one or more contents to be requested by mobile users and forward those contents to one or more cache appliances. For example, storage appliance 120 may contain contents C1 to C100, while contents C1 to C90 may also be stored on storage appliance 155. This arrangement of contents suggests that the CDN provider may expect that contents C1 to C100 are likely to be requested by mobile devices operating within the hierarchical domain associated with gateway foreign agent 115 (the foreign agent to which storage appliance 120 is connected). However, it appears that the CDN provider may not expect contents C91 to C100 to be requested from mobile devices located within the hierarchical domain associated with gateway foreign agent 150.

In addition to storage appliances 120 and 155, an exemplary mobility aware content delivery network in an embodiment may include one or more cache appliances 135, 145, 170, and 180. Cache appliances may be strategically located at selected foreign agents, such as foreign agents 130, 140, 165, and 175, respectively, according to the demands for contents across the areas serviced by the network. The strategic placement of cache appliances at select foreign agents throughout the network facilitates enhanced content delivery by enabling contents desired by mobile users located in the areas serviced by those foreign agents to be stored near those mobile users. For reasons of efficiency, the inventory of contents stored on cache appliances may change frequently, as less often requested contents may be removed from storage on a cache appliance to make room for more highly demanded contents over time.

In FIG. 1, cache appliance 135, attached to foreign agent 130, may currently cache contents C1 to C15. If a mobile device located in the area serviced by foreign agent 130 requests a content other than contents C1 to C15, and thus not locally available on cache appliance 135, the storage appliance 120 may forward the desired content to cache appliance 135, so that cache appliance 135 may provide the desired content to the requesting mobile device. In addition to obtaining contents from storage appliance 120, cache appliance 135 may request to obtain the content from another cache appliance, such as cache appliance 145, which may already cache the requested content.

As described above, a cache appliance may be an external system attached to a foreign agent. Another approach to caching, which may be considered alone or in addition to an external cache, is based on logical caching. In the logical cache approach, content delivery relies on local caching and/or storage resources available on the foreign agent itself, rather than solely on an external cache appliance. The amount of the foreign agent's resources dedicated to logical-caching may be controlled and adjusted to meet the desired performance metrics for the CDN. In one embodiment, these adjustments may be performed dynamically by the foreign agent. In an alternative embodiment, a network administrator may manually perform these adjustments. In yet another embodiment, a portal may be made available to content providers, such that they may have a level of control over the resources available on the foreign agent. The logical cache approach provides for dynamic allocation of resources where and when needed, thus enhancing efficiency and utilization of the CDN. This approach may be supported on foreign agents by utilizing approaches, such as logical partitioning, that can be implemented using modular hardware techniques. Further, this approach allows a single foreign agent to provide content on behalf of multiple content providers.

As referred to above and herein, a foreign agent, including a gateway foreign agent, comprises one or more servers. Each of these servers may comprise one or more non-transient computer-readable mediums and one or more processors. In one embodiment, information is gathered by software running on the processor(s). In a more specific embodiment, the information may be gathered by software implemented as the profilers and other modules discussed below, such as the Unit Mobility Profiler, Group Mobility Profiler, Predicted Mobility Map Module, Content Audience Profiler, Content Processing Profiler, and Utilization Mobility Map Module. Such software may be stored and processed by the one or more non-transient computer-readable mediums and one or more processors of one or more gateway foreign agents. In an alternative embodiment, information gathered by the software, such as these profilers and modules, may be stored and processed by the one or more non-transient computer-readable mediums and one or more processors of one or more (non-gateway) foreign agents. In yet another alternative embodiment, information gathered by the software, such as these profilers and modules, may be stored and processed on one or more systems external to and in communication with one or more gateway or non-gateway foreign agents. Such external systems are comprised of one or more non-transient computer-readable mediums and one or more processors.

As referred to above and herein, a storage appliance and a cache appliance each comprise one or more servers. Each of these servers may comprise one or more non-transient computer-readable mediums and one or more processors. In one embodiment, contents available for distribution to mobile users may be stored and processed on one or more non-transient computer-readable mediums and one or more processors of one or more storage appliances and one or more cache appliances.

In a traditional (stationary) content delivery network, a connection is established to transfer contents from a cache appliance to an end user. In a mobile environment embodiment, a mobile user may move from one service area to another while involved in a content transfer session within the content delivery network. In some situations, the mobile user may be better serviced by a different cache appliance, depending on the service areas among which the mobile user is traveling. In order to address this situation, a number of components are provided to support efficient delivery of contents throughout a mobility aware content delivery network. Collectively, these components extract and analyze information relevant to the mobility of users, the popularity of contents, and associations between groups of mobile users and requested content patterns. This extracted information may then be used to identify the appropriate appliance to serve a particular request.

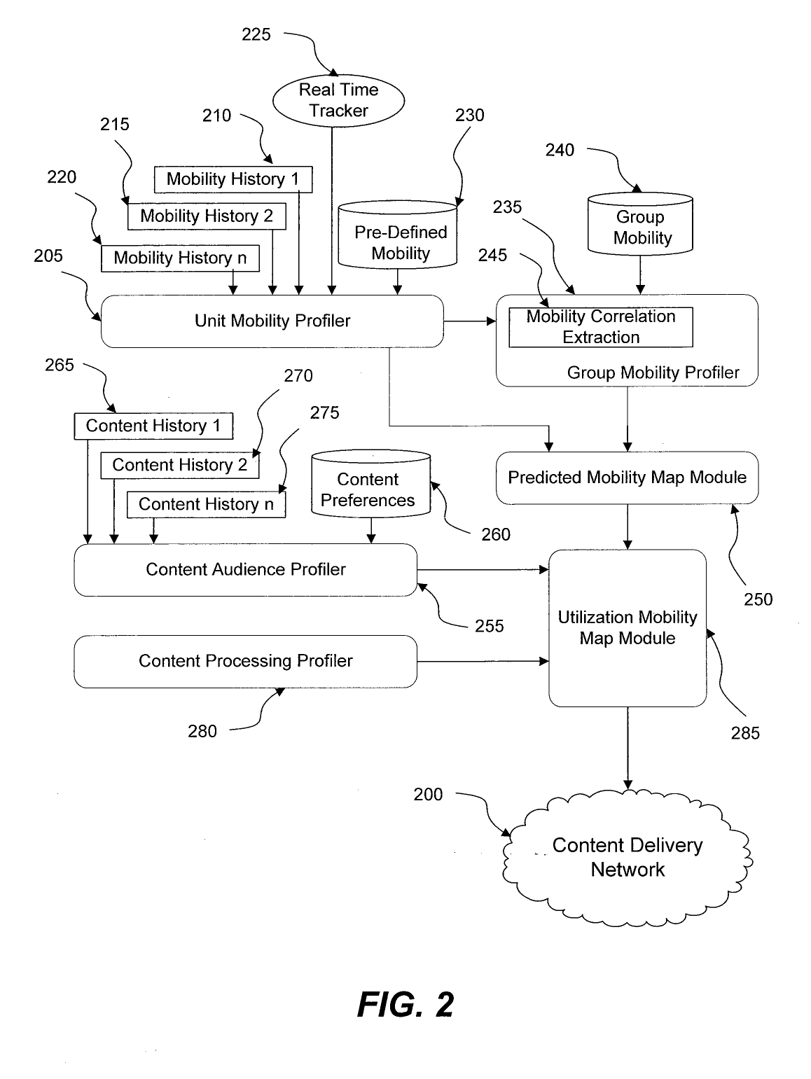

FIG. 2 illustrates a flow diagram depicting exemplary modules and exemplary components involved in supporting a mobility aware content delivery network 200, in accordance with an embodiment. As shown in FIG. 2, the exemplary modules and components function to extract predictive information used when determining a location in the content delivery network at which to pre-position content for a mobile user's request. In this detailed example, a Unit Mobility Profiler 205 and Group Mobility Profiler 235 may collect and store information regarding the mobility patterns of individual mobile users and devices and groups of mobile users and devices. A Content Audience Profiler 255 may track user preferences for available content. A Content Processing Profiler 280 may maintain information regarding content accessible over the network. A Predicted Mobility Map Module 250 may receive information from the Unit Mobility Profiler 205 and Group Mobility Profiler 235 and predict a map showing the expected mobility patterns of individual users and devices, as well as groups of users and devices. Finally, a Utilization-Mobility Map Module 285 may use information obtained from the above-mentioned components to prepare a map reflecting the likely demand on available contents at different locations within the Content Delivery Network 200, such as the areas served by the foreign agents of the content delivery network illustrated in FIG. 1.

A basic element in determining an enhanced placement of contents in a mobility aware content delivery network is the location of the mobile devices requesting access to content stored on the network. Unlike a traditional (stationary) content delivery network, an embodiment with an exemplary mobile aware content delivery network recognizes that the location of a mobile device may change frequently. Accordingly, a mobile aware CDN may gather information regarding the habits or patterns of one or more mobile users and mobile devices (or even groups of users or devices) in order to anticipate where on the network one or more contents desired by a mobile user could advantageously be placed. In one example, the Unit Mobility Profiler 205 and Group Mobility Profiler 235 may provide this functionality.

The Unit Mobility Profiler 205 is a software module that operates to monitor the mobility of one or more mobile devices to create a unit mobility profile. A unit mobility profile is a type of predictive information that comprises information obtained from one or more sources of information regarding the mobility of an individual mobile device, such as, but not limited to, mobility history 210, 215, 220, a real time tracker 225, and a pre-defined mobility pattern database 230. Each of these sources of information may represent past or current data on the mobility of an individual mobile device that can be analyzed to predict future mobility of the device.

A mobility history may be created based on past mobility data for an individual mobile device. The mobility histories of three different exemplary mobile devices are illustrated in FIG. 2 as mobility histories 210, 215, and 220. When a user of a mobile device travels across a number of service areas, a mobility history, such as mobility history 210, may be created or modified to record the presence of the device in each area. As discussed above, these modifications may be performed by one of the gateway or non-gateway foreign agents within the CDN. In one embodiment, these modifications may be performed by the foreign agent that is currently providing service to the mobile device. In an alternative embodiment, the gateway foreign agent that links the foreign agent serving the mobile device to the intermediate network may perform these modifications. In yet another embodiment, these modifications may be performed by a device external to but in communication with a gateway or non-gateway foreign agent within the CDN.

For each of the service areas visited by the mobile device corresponding to mobility history 210, the duration of time that the device was located within that service area may be stored along with the data noting the mobile device's presence in the service area. In an example, an entry in mobile history 210 of [SA1/300, SA2/300, SA3/600] may indicate that the mobile device corresponding to mobility history 210 was located in service area 1 for 5 minutes (300 seconds), in service area 2 for 5 minutes (300 seconds), and in service area 3 for 10 minutes (600 seconds). Alternatively, the mobile history may specify the exact time of day in which the mobile device entered a service area. For example, the entry [SA1/13:00:00, SA2/13:03:00, SA3/13:05:00] in mobility history 215 may indicate that the mobile device corresponding with mobility history 215 entered service area 1 and 1:00 PM, service area 2 at 1:03 PM, and service area 3 at 1:05 PM. As yet another alternative, the mobility history may specify the exact time of day at which the mobile device entered a service area and the exact time of day that the device departed the service area. For example, the entry [SA1/13:00:00-13:02:59, SA2/13:03:00-13:04:59, SA3/13:05:00-13:10:30] in mobility history 220 may indicate that the mobile device corresponding with mobile history 220 entered service area 1 at 1:00 PM and left 1 second prior to 1:03 PM, etc.

Whereas information regarding the past mobility of an individual mobile device or user is stored in a corresponding mobility history, information regarding the current mobility of an individual mobile device or user may be tracked and maintained by the real time tracker 225. Generally, the real time tracker 225 provides data to the Unit Mobility Profiler 205 related to the current location of the individual mobile device or user. In one example, real time tracker 225 may provide real time information related to mobility events, such as latitude/longitude data representing a mobile device's current location as determined by the Global Positioning System (GPS). The foreign agent may also provide information related to the mobile users currently visiting its area. Therefore, the real time tracker 225 may ensure that the placement of content desired by a mobile user is based on up-to-date information regarding the location of the user. The information provided by the real time tracker 225 may be used, for example, to determine whether an individual mobile device is receiving service at a location consistent with the mobility history of that device, or whether the device is deviating from the normal mobility pattern for that device and is located in or heading toward a service area at a time of day in which the device is typically located elsewhere. Thus, the real time tracker 225 may enable the CDN to determine a location within the CDN at which to pre-position the content prior to receiving a request for the content from a mobile user. Accordingly, the CDN may provide enhanced quality of service to a mobile user regardless of whether the user is following a typical routine.

In one embodiment, the role of real time tracker 225 for a given mobile device may be performed by the foreign agent currently providing the mobile device access to network services. In such a case, the foreign agent may update the Unit Mobility Profiler 205 when the mobile device enters the area serviced by the foreign agent. In an alternative embodiment, an authentication server within the mobility domain of the CDN in which the mobile device is located may perform the tracking role. Accordingly, the authentication server may be provisioned to supply information regarding mobility events to the Unit Mobility Profiler 205.

In developing a unit mobility profile, the Unit Mobility Profiler 205 may also analyze information stored in the pre-defined mobility pattern database 230. Although mobile users may follow any number of mobility patterns while operating a mobile device on the network, some mobile users may follow a pre-determined pattern. In one example, such a pre-determined pattern may identify, for example, the service areas visited by a mobile user, the order in which the user visits each of the service areas, and the amount of time spent by the user in each service area. A mobile user may upload from a mobile device such a pre-determined pattern to the pre-defined mobility pattern database 230. Alternatively, database 230 may be pre-loaded with the pre-determined pattern. For example, the mobility path of a user may be determined in advance by a mobility management application. The application may store the mobility pattern into the pre-defined mobility pattern database 230. Mobility patterns stored in the pre-defined mobility pattern database 230 may be used along with or in place of mobility histories and information received from the real time tracker 225 to form a unit mobility profile for a mobile device or user.

Whereas the Unit Mobility Profiler 205 may compile data regarding the mobility of an individual mobile device and mobile user, the Group Mobility Profiler 235 may collect data regarding the mobility of one or more groups of mobile devices and mobile users. In operation, the Group Mobility Profiler 235 may identify and analyze associations between the mobility of one mobile user or device and that of other mobile users and devices. An embodiment of the Group Mobility Profiler 235 implements the association identification and analysis capability with a particular function called a mobility correlation extraction function 245. Analysis performed by the mobility correlation extraction function 245 may reveal that the mobility patterns of certain mobile devices or users tend to follow, or otherwise resemble, the mobility patterns of one or more other mobile devices or users. By tracking such relationships between mobility patterns of different mobile users and devices, the Group Mobility Profiler 235 provides another type of predictive information that may be used to extract information when determining where to strategically pre-position content within the network.

In general, a correlation between the mobility of multiple devices and users may be expected based upon differentiating factors. For example, such differentiating factors may include conferencing, mobile networks, emergency, and ad-hoc environments. In one example, business demands may increasingly require businesspersons who are scattered across a wide geographic area to collaborate with one another in real time, including at a moment's notice, when those persons may be traveling or otherwise located outside of the home or office. In such a situation, those persons may set up a conference requiring communications over mobile devices scattered throughout a network. In that example, if the mobility correlation extraction function 245 has previously determined that the mobility patterns of those persons and their devices are often interrelated, the Group Mobility Profiler 235 may provide predictive information-indicating it is appropriate to place contents requested by one of those persons in locations where they are efficiently deliverable to those persons and their devices.

As another example of a scenario in which the mobility of one individual mobile device or user may be related to the mobility patterns of one or more other mobile devices or users, emergency situations will often result in a related set of mobile devices and users demanding similar contents at the same location. For example, when a person requests assistance from emergency services, a number of emergency personnel may respond, such as, for example, policemen, fireman, and emergency medical technicians. Accordingly, the mobility correlation extraction function 245 may determine that the mobility patterns of certain emergency personnel and their devices are interrelated and report this finding to the Group Mobility Profiler 235. Each of these emergency personnel may require access to certain content via mobile devices when responding to the emergency call. Because the Group Mobility Profiler 235 is aware of this relationship, it may permit the contents needed by these personnel to be distributed to locations servicing each of the personnel when as few as one of the personnel requests content that suggests additional personnel may soon need access to the same content.

In one embodiment, the Group Mobility Profiler 235 may obtain information regarding relationships among a number of mobile devices and users based on data stored in the group mobility database 240. The group mobility database 240 may contain data regarding pre-arranged group mobility patterns. Such pre-arranged group mobility patterns may be determined by mobile users based on their relationships with other mobile users and maintained by the group mobility database 240, for example, by an application accessible by a mobile user providing for entry of data regarding such relationships. For example, businesspersons who frequently participate in teleconferences with one another may submit data concerning this relationship to the group mobility database 240. This data may be used, for example, to direct pre-positioning of content to service areas at which each of the businesspersons in the stored relationship are located when it is detected that any one of them is requesting certain contents. In other words, when one user requests content that is likely to be requested by other users, the content may be pre-positioned to service areas at which those other users are expected to be located prior to those users' arrival at those service areas. Alternatively, the group mobility database 240 may store additional information specifying, not only the identities of the businesspersons and devices in the relationship, but also information, such as the time at which the content is likely to be requested by those individuals and the service areas in which those individuals are likely to be located when they request the content. In summary, the Group Mobility Profiler 235 gathers a type of predictive information related to a pattern of mobility based upon a grouping of mobile users.

In the embodiment illustrated in FIG. 2, data gathered from the Unit Mobility Profiler 205 and the Group Mobility Profiler 235 may be provided to the Predicted Mobility Map Module 250. The Predicted Mobility Map Module 250 may analyze the information it receives from these profilers regarding the mobility patterns of individual mobile users and devices and groups of mobile users and devices to extract information on the mobility patterns into the form of a map. In more detail, Predicted Mobility Map Module 250 creates a map representing likely or predicted future mobility patterns of those and other mobile devices and users. In other words, in this example, the Predicted Mobility Map Module 250 may determine the service areas that a mobile device is likely to visit at a specific time based upon data representing (1) the service areas in which mobile devices have been and are currently located and (2) the times during which those devices were located in those areas.

In addition to modules that gather information regarding the mobility patterns of mobile users and devices, an embodiment of a mobility aware content delivery network may also contain modules to gather information regarding contents available for delivery on the network. In one example, a Content Audience Profiler 255 and Content Processing Profiler 280 are provided to compile and analyze such information. When combined with data regarding predicted mobility patterns for mobile devices and users, the information gathered by these content profilers better accommodates potential demands for content by mobile devices and users located within the network.

In the illustrated example of FIG. 2, the Content Audience Profiler 255 may track and provide information on the content preferences of individual mobile users. Content preferences for an individual mobile user may be stored, for example, in a request profile (not shown). This request profile may include data regarding particular content requested by a mobile user in the past, as well as information regarding particular classes of content to which individual content accessed by the mobile user belongs. For example, the request profile may identify that a particular user frequently requests a video excerpt regarding a sports event, such as a highlight from a football game or a post-game analysis of a game. In addition to storing data regarding the user's interest in particular content, the request profile may also identify more generally that the user is interested in a SPORTS category of content. Along with identifying the particular content accessed by a mobile user and the class or classes to which that content belongs, another example of the request profile may further store other information regarding content in which a mobile user has an identified interest. Such additional information may include, but is not limited to, the type of content requested (e.g., images, text, video, audio) and the name of the third-party provider of the content.

The Content Audience Profiler 255 may also analyze the content preferences of groups of mobile users. For example, the Content Audience Profiler 255 may determine that a certain group of mobile users has previously accessed a certain class of content on a regular basis and, therefore, future content requests by users in that group are likely to be related. Further, the Content Audience Profiler 255 may compare the request profiles of individual mobile users to detect trends in the content preferences of users as reflected in the particular contents and classes of contents requested by those users. For example, the Content Audience Profiler 255 may determine that users who frequently access content from content classes A and B within a short period of time generally follow those requests with a request for content from content class C. Consequently, if a user has requested content from both content classes A and B, it may be likely that the user will soon request content from content class C. Therefore, it may be advantageous to pre-position content from content class C at an appliance located near the foreign agent currently servicing the user. This may be true regardless of whether that user has requested content from content class C in the past. Because the Content. Audience Profiler 255 analyzes content preferences of multiple users to determine patterns in content preferences, it can recognize the likelihood that a user may request certain content, even if the user has never before requested that content, because the user appears to have content preferences otherwise similar to other users on the Content Delivery Network 200.

Along with content preferences of individual users and groups of users as reflected in the contents previously accessed by those users, the Content Audience Profiler 255 may also store information regarding memberships or subscriptions to services associated with content delivery in a subscriber-content preference database 260. A user's subscription to a particular service may be a very good indicator that the user is likely to request access to content associated with that service in the future. Such a subscription may also indicate that the user has an interest in obtaining similar content (i.e., content of the same class) to that provided through the subscription. Further, the Content Audience Profiler 255 may also analyze the subscriptions of a number of individual mobile users to detect trends in content preferences.

The Content Audience Profiler 255 may obtain information regarding a user's content preferences from sources in addition to the subscriber-content preference database, such as through billing systems of a service provider, a content provider portal, or directly from the user through an application on the user's mobile device. The billing systems of the service provider may provide the most complete listing of contents accessed by a user over a given period of time, as the user may be billed by the service provider based on the amount of network resources consumed by the user. Accordingly, the service provider may note a user's access to content in its billing systems by, for example, including basic information regarding the user's access to the content, such as an identification number representing the content and amount, date and time of access, and number of bytes of information transferred over the network to the mobile user in delivering the content.

The user may also specify particular content or classes of content of interest to the user via, for example, an application on the user's mobile device. Such an application may provide the user with a listing of content classes in which the user may indicate an interest. Further, the user may indicate that the user generally desires to receive content of a particular type, such as text, images, video, or audio. Such content may further be associated with one or more content classes, such as sports, politics, business, and science. Information provided by a user via such an application may be particularly useful in determining the placement of contents if the user has little history of requesting contents over the network, and therefore minimal data on which otherwise to base decisions regarding placement of contents for access by the user.

The Content Audience Profiler 255 may also gather information regarding a user's content preferences from information provided by a content provider. Generally, an embodiment of a mobility aware content delivery network may distribute content developed by a wide variety of content providers. These content providers may maintain data regarding users' access to their content. Further, as the developers of the content being requested by the users, content providers may have useful information regarding similar content that may be requested by users in the future based on their understanding of the relationships between the user and various content they provide.

In an example, Content Audience Profiler.rnay store information regarding the content preferences of an individual mobile user in a content preference database 260, as illustrated by the following exemplary database entries. Entry 1: Mobile device A is interested in content #20010 and content #20011 while mobile device A is located in areas serviced by foreign agents 355, 360, and 365. Entry 2: Mobile device B is interested in content class “SPORT” when time is between 19:00:00 and 22:00:00. Entry 3: If mobile device C requests content from content class MAINTENANCE-TURBINE-1001 between 18:00:00 and 23:00:00, then mobile devices D, E, F, and G will request content from content class MAINTENANCE-TURBINE-1002 in 15 minutes. Entry 4: If mobile device H requests content #39001, then mobile device H will request content #39002 after the conclusion of the playing of content #39001, and will then request content #39003 after the conclusion of the playing of content #39002.

Whereas the Content Audience Profiler 255 may maintain data regarding the content preferences of mobile users, the Content Processing Profiler 280 may store data regarding aspects of the content itself. Such data may include information such as content identification number, duration of content (e.g., time of play for an audio or video clip), bit rate, and associated content identification. Other modules may use the information provided by the Content Processing Profiler 280 to provide efficient content forwarding. For example, information regarding the duration of a video and the bit rate of the video may be used by the Utilization Mobility Map Module 285 to divide the video into segments that may be delivered or pre-positioned to a number of appliances servicing the areas in which a mobile user may travel while receiving the content.

One content may be associated with one or more other contents. The Content Processing Profiler 280 may store such relationships between different content, so that other modules, such as the Utilization Mobility Map Module 285, may use information regarding those relationships in determining how efficiently to distribute contents to appliances within the Content Delivery Network 200. In some instances, associated contents may be part of a sequence, such as a video that is delivered in multiple subparts. For example, training videos delivered over mobile devices may be separated into multiple subparts based on size of the videos or on logical separation of the topic into a number of steps. Therefore, it is likely that a user may request delivery of those videos according to that sequence. Accordingly, if the Content Processing Profiler 280 indicates that a first training video is associated with four additional training videos, then, when a user requests delivery of the first training video, other modules, such as the Utilization Mobility Map Module 285, may reflect that the second through fifth training videos need to be distributed to areas within the Content Delivery Network 200 that the user is likely to visit, as determined according to data received regarding the user's mobility patterns.

In an example, information regarding characteristics of individual contents may be stored in the Content Processing Profiler 280 as follows: [Content ID=770020, Duration=30 minutes, Bit Rate=3.75 Mbps, Associated Content=Content ID 770021].

Data collected and maintained by the Unit Mobility Profiler 205, Group Mobility Profiler 235, Predicted Mobility Map Module 250, Content Audience Profiler 255, and Content Processing Profiler 280 may be compiled and analyzed by the Utilization Mobility Map Module 285. The Utilization Mobility Map Module 285 may create a map reflecting expected content-usage information. More particularly, this map may represent the anticipated demand for available content at a specified period of time at different locations within the Content Delivery Network 200. The utilization map may be used to identify where appliances should be placed within the CDN and also further used to identify the appropriate appliances to handle the content. Further, the information gathered in this module may be used to determine how appropriately to segment content and deliver the segmented content to one or more network nodes when a user is expected to require access to content while traveling through multiple service areas.

When appropriate, the Utilization Mobility Map Module 285 may determine that the CDN would provide certain contents to users more efficiently if those contents were stored on a different cache appliance that that on which those contents are currently stored. Several factors may influence this determination, such as, but not limited to, demand for a particular type of content, user and group mobility patterns, and desired level of service. For example, using the same cache appliance to service a mobile device that is moving from one service area to the next service area may require that requested content travel over a large number of hops to reach the service area where the mobile device is currently located. Accordingly, the Utilization Mobility Map Module 285 may update the utilization map and cause a repositioning of content due to the relocation of mobile users to different service areas. In a more specific example, an international sporting event may be held in country X. Because this particular sporting event is not very popular in country X, it may be determined that the content associated with this sporting event are generally in low demand within the network. Accordingly, a small number of caches may be caused to carry such content. When this international sporting event is started, a large number of mobile user may roam within the cities where the event is organized. The Utilization Mobility Map Module 285 may detect this situation, and consequently, may direct the content associated with this sport to a larger number of appliances, and specifically, to appliances in locations suitable for this new temporary market.

In the example noted above regarding exemplary information stored in Content Processing Profiler 280, the information may be forwarded by the Content Processing Profiler 280 to the Utilization Mobility Map Module 285 to determine the appropriate allocation of contents among service areas of the network. For example, if mobile device A is traveling between areas serviced by foreign agents 350, 355, and 160 within 30 minutes and has requested content #770020 while in the area serviced by foreign agent 350, then the contents (both #770020 and associated content #770021) may need to be forwarded to 3 different service areas. The Utilization Mobility Map Module 285 may use this information to develop an efficient plan forwarding these contents to mobile device A as it travels through these areas.

To address further the efficiency concerns that may arise when mobile users travel among different services areas, contents may be divided into segments and distributed across a number of cache appliances. The ability to transfer partial content in segments at one or more network locations provides flexibility that may enhance network performance and reduce overhead associated with content retransmission. A single content may be segmented in a manner that facilitates managing the requesting and forwarding of partial contents by applications running on mobile devices connected to the network. For example, a prerecorded one-hour training video can be segmented into twelve 5-minute segments. If the CDN identifies that it is appropriate to assign a different cache appliance to service a content in the middle of a transfer, the network can select the time to switch between appliances to coincide with the time at which one segment of the content ends and the next segment begins.

When the CDN delivers content in segmented form, some mobile devices may more efficiently receive the content with advanced warning of the segmented form. For example, an application receiving the content may need to accept both a primary and a backup connection end-point, handle connection retries, address identification and management of received partial contents, and possess the ability to request partial contents. With this additional information, the CDN may accomplish efficient delivery of the content in partial or segmented form.

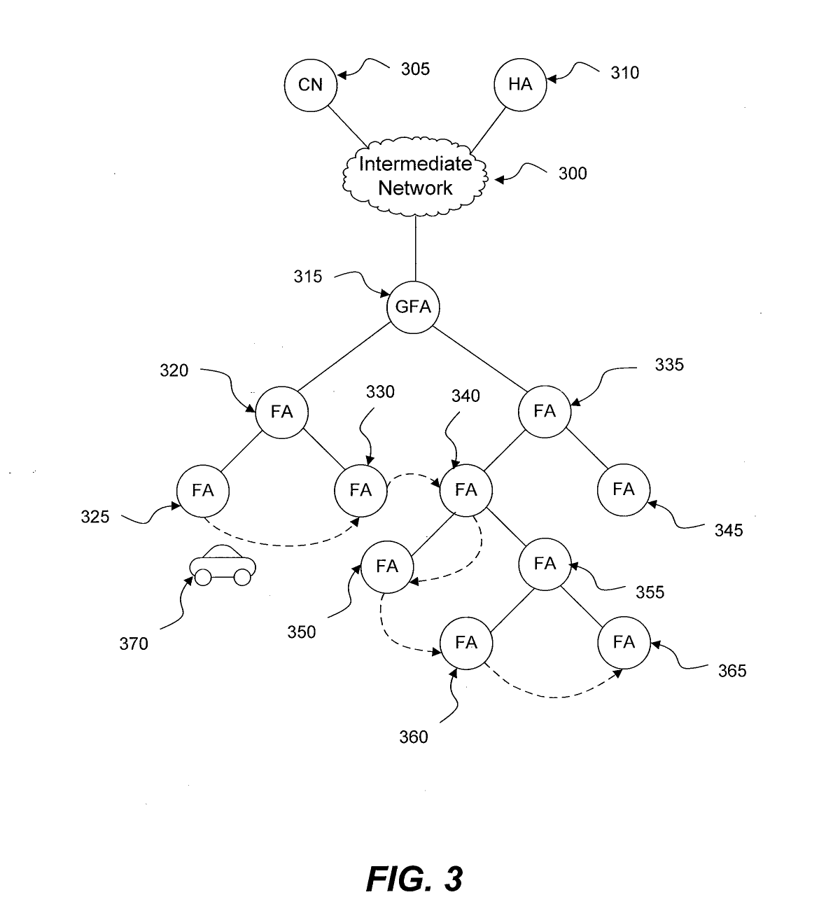

FIG. 3 depicts an exemplary mobility aware content delivery network and a possible mobility pattern associated with a mobile device 370 traveling within the network, in accordance with an embodiment. The possible mobility pattern is illustrated by a series of hops, represented by arrows between foreign agents, beginning at foreign agent 325 and ending at foreign agent 365. This mobility pattern may be stored in the Unit Mobility Profiler in the following format: [visited area/time spent in this area (in seconds)]. Accordingly, the following entry may be stored to represent the mobility pattern illustrated by FIG. 3: [FA325/120, FA330/40, FA340/120, FA350/20, FA360/50, FA365/120]. Such an entry may indicate that mobile device 370 was located in the area serviced by foreign agent 325 for 2 minutes (120 seconds), the area serviced by foreign agent 330 for 40 seconds, etc. Such information, along with data regarding the time that the mobile device 370 arrived at the first service area in the path, may be used to predict the location of the mobile device 370 at a particular time. For example, if mobile device 370 registers with foreign agent 330 at time 17:25:10, then it is expected that the mobile device 370 will reach foreign agent 340 at 17:25:50 (40 seconds later). In order to keep current the mobility pattern data stored in the Unit Mobility Profiler, the current foreign agent servicing the mobile device 370 may play the role of real time mobility events tracker. Continuing with the previous example, at time 17:25:30, foreign agent 330 may serve as real time tracker 225 for mobile device 370, as mobile device 370 is located within the service area of foreign agent 330 at that time.

As discussed above, mobility patterns of a number of individual mobile devices and users may be interrelated. In the example illustrated in FIG. 2, such relationships may be stored in the Group Mobility Profiler 235. In some circumstances, the correlation between the mobility of two or more mobile devices may be known in advance of the devices' requests for content delivery. In such a case, dependency information may be stored in a group mobility database, such as database 240. The following exemplary rules illustrate possible relationships that may be stored in the group mobility database. Rule 1: If mobile device A moves to a new service area, then mobile devices B and C will follow to the same service area within 2 minutes (with 80% probability). Rule 2: If mobile device A moves to a new service area and that new service area is serviced by one of foreign agents 350, 355, and 360, then mobile devices D and E will follow to the same service area within 5 minutes. Rule 3: If mobile device A moves to a new area, and the time is between 12:00:00 and 13:00:00, then mobile device F will follow to the same service area.

Such rules may allow the system to predict the mobility of one or more mobile devices based on knowledge about the mobility of another mobile device. For example, Rule 1 helps to predict the mobility and location of mobile devices B and C based on information related to the mobility of mobile device A.

In addition to these exemplary preset rules stored in the group mobility database, the Group Mobility Profiler 235 may receive information, such as the above-discussed mobility pattern of mobile device 370, from the Unit Mobility Profiler 205. Such information on the mobility of individual mobile devices and users may be input into the mobility correlation extraction function 245 of the Group Mobility Profiler 235 to identify relationships between mobility events of different mobile devices and users. This analysis may result in a set of rules similar to preset rules A, B, and C, discussed above. A number of different approaches may be employed in an embodiment to determine these rules, such as pattern recognition, neural networks, data mining, and statistical analyses.

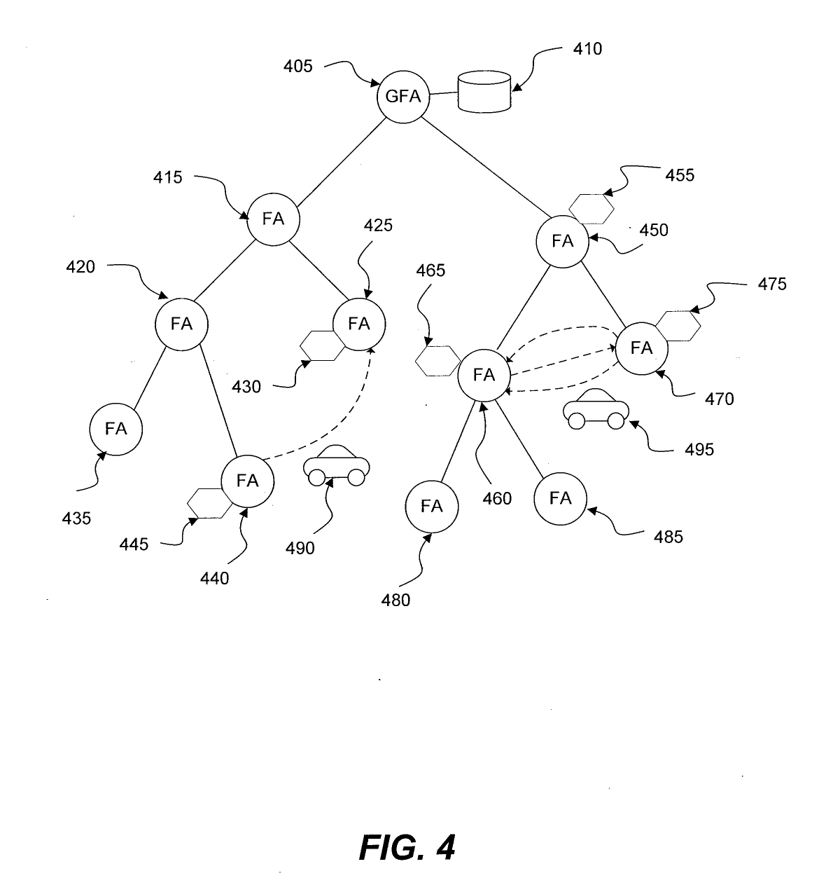

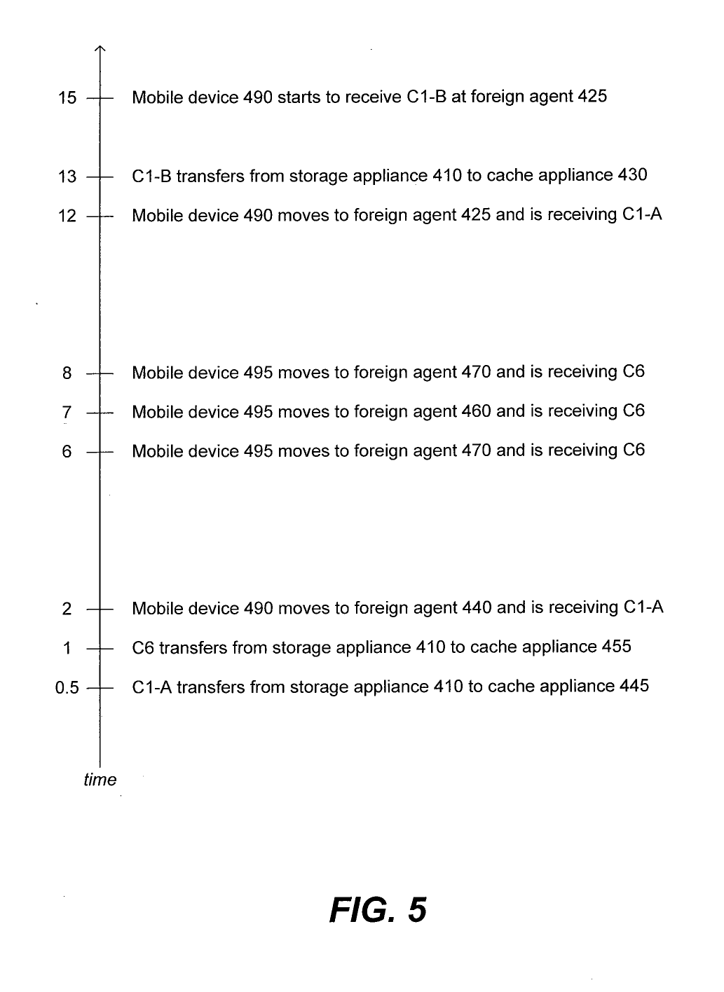

FIGS. 4 and 5 illustrate an exemplary delivery of contents to two mobile devices located on an exemplary mobility aware CDN according to analysis performed by the Utilization Mobility Map Module 285 executing within the CDN, such as on a gateway or non-gateway foreign agent, as discussed above. In this example, storage appliance 410 contains contents C1 to C10 and is supported by foreign agent 405. Cache appliances 430, 445, 455, 465, and 475 are available at foreign agents 425, 440, 450, 460, and 470, respectively. At time 2, mobile device 490 was at the service area associated with foreign agent 440. Mobile device 490 is interested in receiving content C1. While receiving content C1, mobile device 490 moves to the area serviced by foreign agent 425 at time 12. Mobile device 495 is interested in receiving content C6, Mobile device 495 starts at foreign agent 470 and then moves to foreign agent 460 at time 6, back to foreign agent 470 at time 7, and back again to foreign agent 460 at time 8.

Using the aforementioned information regarding the mobility patterns and content preferences of mobile devices 490 and 495, the Utilization Mobility Map Module may develop a utilization mobility map for a configurable period of time. The Utilization Mobility Map Module 285 may identify the appropriate cache appliances to serve content requests by mobile devices 490 and 495 and may also identify the appropriate segments of desired content to forward at a particular time. The Module may identify that content C1 and content C6 are not available on the desired cache appliance. Thus, the storage appliance 410 may be instructed to forward content segment C1-A to foreign agent 440 and content C6 to foreign agent 450. Based on the mobility pattern of mobile device 490, the Module may select cache appliance 445 to service mobile device 490 while that device is located in the area serviced by foreign agent 440. Then, the Module may instruct the storage appliance 410 to forward the second segment of C1, C1-B, to the next service area for the mobile device 490, which is the area serviced by foreign agent 425. The storage appliance 410 may start to transfer the content at time 13. Such delay may allow the system to consider a corrective action in case new information suggests a change in the predicted mobility path of mobile device 490, without affecting the transfer performance aspects. Because the mobility pattern of mobile device 495 indicates frequent roaming between foreign agents 460 and 470, the Module may decide that it is more efficient to use the cache appliance 455 at foreign agent 450 to forward content C6 to mobile device 495 than to store content C6 on both cache appliances 465 and 475.

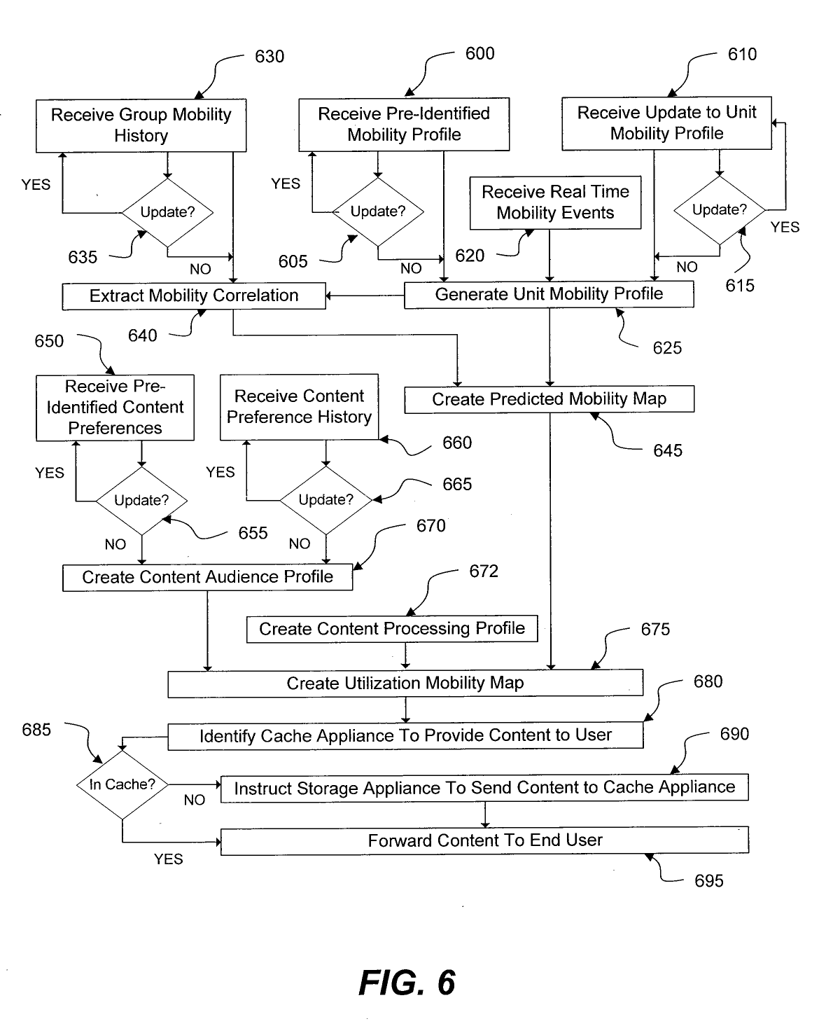

FIG. 6 provides an illustration of the flow between the various modules used to support an exemplary mobility aware CDN in accordance with an embodiment. As discussed above, these modules may execute on one or more gateway or non-gateway foreign agents within the CDN. Alternatively, these modules may execute at one or more devices external to but in communication with one or more gateway or non-gateway foreign agents within the CDN. At steps 600 and 610, data regarding a pre-identified mobility profile and a unit mobility profile are received. These data may be updated at steps 605 and 615 and analyzed along with data regarding real time mobility events, received at step 620, to generate a unit mobility profile at step 625. At steps 630 and 635, information regarding group mobility history is received and updated. Data received regarding unit and group mobility are analyzed together at step 640 to extract a mobility correlation that may be used, along with the unit mobility profile, to create a predicted mobility map at step 645.

At steps 650 and 660, data regarding pre-identified subscriber content preferences and content preference history are received. After checking for updates to these data at steps 655 and 665, a content audience profile is created at step 670. At step 672, a content processing profile is created. Next, the content audience profile, content processing profile, and predicted mobility map are analyzed together at step 675 to create a utilization mobility map. Cache appliances that will be used to provide content to a user are identified at step 680. Step 685 seeks to determine whether contents are currently found in the appropriate cache appliances. If contents are not already located in the proper cache appliances, then storage appliances are instructed to send contents to the appropriate cache appliances at step 690. At step 695, it has been determined that the content is located in the appropriate cache appliance and, therefore, the content is forwarded to the mobile device that requested the content.

Several modules have been disclosed for determining a proper distribution of contents within a mobility aware CDN. Multiple approaches are available to extract mobility and content demand patterns, such as neural networks, pattern recognition, genetic algorithms, data mining, and statistical analysis. These tools may be used to provide a set of rules or formulas that can be used to predict the future mobility of mobile devices and users, as well as content requests, based on data regarding past and current events.

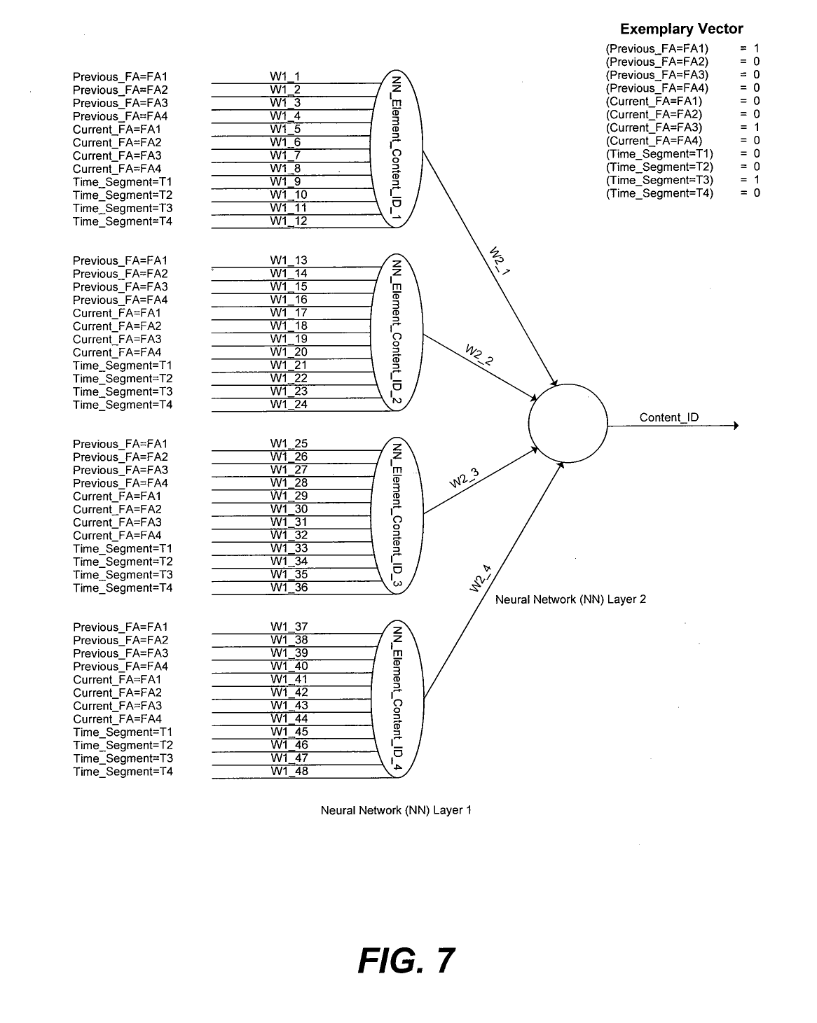

FIG. 7 illustrates an exemplary neural network used to predict contents that are likely to be requested by a particular mobile device, in accordance with an embodiment. For simplicity, this figure assumes a network with only four foreign agents and four contents. In the first layer of processing elements in the neural network system, inputs representing information such as previous foreign agent, current foreign agent, and time segment are received. Each element in this layer may be associated with a particular content. Each input may be processed by a weight that correlates to the corresponding input's influence into the output. The example illustrated by FIG. 7 corresponds to a mobile device that was previously located in the area serviced by foreign agent 1 and is currently located in the area serviced by foreign agent 3. The time period of interest in this example is 12:00:00 to 18:00:00 (time segment T3). This information is represented by the exemplary vector shown in FIG. 7.

The resulting output of each processing element may then be directed to a second layer of one or more processing elements. In this example, the second layer includes a single element. Again, each input coming into this element (which corresponds to an output from the previous layer) may be processed by a weight (e.g., W2_1, W2_2, W2_3, or W2_4). The single element in the second layer provides an output that may identify the likely next content ID that will be requested by this particular mobile user.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method of distributing contents within a mobility aware content delivery network, comprising:
storing, on a computer-readable storage medium, information related to at least one mobility pattern and at least one content preference;
creating, using a processor, a utilization map that represents an expected mobility pattern and expected content usage information based on the stored information; and
identifying, using a processor, at least one location in the network to place at least one content, wherein the at least one location is identified based on the utilization map.

2. The method of claim 1, wherein the at least one mobility pattern is based on the order in which at least one mobile device visits a plurality of service areas and the amount of time spent by the at least one mobile device in each of the plurality of service areas.

3. The method of claim 1, wherein the at least one mobility pattern comprises at least one unit mobility pattern containing information associated with a single mobile device.

4. The method of claim 1, wherein the at least one mobility pattern comprises at least one group mobility pattern containing correlation data regarding the mobility of multiple mobile devices.

5. The method of claim 1, wherein the at least one content preference is determined based on a content request history associated with at least one mobile device.

6. The method of claim 1, wherein the at least one content preference is determined based on a service associated with a class of content.

7. The method of claim 1, wherein the at least one content is divided into a plurality of content segments; and
wherein the step of identifying further comprises identifying, using the processor, a first location in the network to store a first of the plurality of content segments and a second location in the network to place a second of the plurality of content segments based upon the utilization map.

8. A system of distributing contents within a mobility aware content delivery network, comprising:
a memory that stores information related to at least one mobility pattern and at least one content preference; and
a processor coupled to the memory and configured to:
create a utilization map that represents an expected mobility pattern and expected content usage information based on the stored information; and
identify at least one location in the network to place at least one content, wherein the at least one location is identified based on the utilization map.

9. The system of claim 8, wherein the at least one mobility pattern is based on the order in which at least one mobile device visits a plurality of service areas and the amount of time spent by the at least one mobile device in each of the plurality of service areas.

10. The system of claim 8, wherein the at least one mobility pattern comprises at least one unit mobility pattern containing information associated with a single mobile device.

11. The system of claim 8, wherein the at least one mobility pattern comprises at least one group mobility pattern containing correlation data regarding the mobility of multiple mobile devices.

12. The system of claim 8, wherein the at least one content preference is based on a content request history associated with at least one mobile device.

13. The system of claim 8, wherein the at least one content preference is based on a service associated with a class of content.

14. The system of claim 8, wherein the processor is further configured to identify a time at which to place the at least one content at the at least one location in the network.

15. The system of claim 8, wherein the at least one content is divided into a plurality of content segments that are distributed among a plurality of locations in the network based on the utilization map.

16. The system of claim 15, wherein each of the plurality of content segments is distributed among the plurality of locations in the network based on at least one of content duration and delivery bit rate.

17. A computer-readable storage medium including instructions for provisioning content within a mobility aware content delivery network, which, when executed, performs the steps comprising:
storing information related to at least one mobility pattern and at least one content preference;
creating a utilization map, based on the stored information, representing an expected mobility pattern and expected content usage information; and
identifying, based on the utilization map, at least one location in the network to place at least one content.

18. The computer-readable storage medium of claim 17, wherein the at least one mobility pattern is based on the order in which at least one mobile device visits a plurality of service areas associated with the network and the amount of time spent by the at least one mobile device in each of the plurality of service areas.

19. The computer-readable storage medium of claim 17, wherein the at least one mobility pattern comprises at least one group mobility pattern containing correlation data regarding the mobility of multiple mobile devices.

20. The computer-readable storage medium of claim 17, wherein the at least one content preference is determined based on a content request history associated with at least one mobile device.

21. The computer-readable storage medium of claim 17, wherein the at least one content preference is determined based on a service associated with a class of content.

22. The computer-readable storage medium of claim 17, wherein the at least one content is divided into a plurality of content segments, and wherein the step of identifying further comprises identifying, using the processor, a first location in the network to store a first of the plurality of content segments and a second location in the network to place a second of the plurality of content segments based on the utilization map.

23. A computer-implemented method of provisioning a mobility aware content delivery network, comprising:
extracting a pattern of mobility and content preference from predictive information related to a mobile user of the content delivery network; and
determining a location in the content delivery network to store content based upon the extracted pattern of mobility and extracted content preference; and
pre-positioning the content at the determined location in the content delivery network prior to a request for the content from the mobile user.
